(19) United States
(12) Patent Application Publication
(10) Pub. No.: US 2007/0040839 A1
(43) Pub. Date: Feb. 22, 2007

(54) MOTHERBOARD AND COMPUTER SYSTEM WITH MULTIPLE INTEGRATED GRAPHICS PROCESSORS AND RELATED METHOD

(76) Inventor: Tzu-Jen Kuo, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/161,822

(22) Filed: Aug. 17, 2005

(51) Int. Cl. G06F 13/14

(52) U.S. Cl. 345/519

(57) ABSTRACT

Motherboards with multiple integrated graphics processors (IGPs) for performing graphics processing operations are disclosed. A proposed motherboard includes a first integrated graphics processor (IGP) having a first north bridge circuit and a first graphics processing circuit; at least one second IGP, each having a second north bridge circuit and a second graphics processing circuit; and a south bridge circuit coupled to the first north bridge circuit.

### BACKGROUND OF THE INVENTION

1. Field of the Invention

The present invention relates to a computer system, and more particularly, to a motherboard and a computer system equipped with multiple integrated graphics processors for rendering images and related method.

2. Description of the Prior Art

The graphics processing systems employed to render high quality and realistic images play an increasingly important role in modern computer systems. Typical graphics processing systems are often implemented utilizing expansion cards. These expansion cards, specifically graphics cards, are inserted into appropriately configured slots on a motherboard of a computer system. The graphics cards generally include one or more dedicated graphics processing units (GPUs) and a dedicated graphics memory.

To achieve greater realism and higher speeds, some hardware developers have introduced graphics cards equipped with more powerful and more complex GPUs. Additionally, the hardware developers increased the graphics memory capacity to improve performance speed by reducing traffic on the system bus.

Another approach utilized by some hardware developers for increasing the performance of the graphics processing system has been to adopt a multi-card architecture in which two or more graphics cards are installed in a computer system. The cards function to perform graphics processing operations in parallel. Parallel operation substantially increases the processing power of the graphics cards because the number of rendering computations that can be performed per second per card can be combined. However, the multi-card architecture requires an additional high-speed bridge card. For example, a high-speed bridge card such as a PCI-E bridge card is needed to interconnect the different graphics cards. The implementation cost is thereby increased due to the necessary addition of the high-speed bridge card. Moreover, the multi-card architecture requires considerable space for the installation of the multiple graphics cards. This space requirement may be not feasible in some applications where the system volume is a concern, e.g., in laptop computers.

### SUMMARY OF THE INVENTION

According to one aspect of the invention, a motherboard is disclosed comprising: a first integrated graphics processor (IGP), positioned on the motherboard, the first IGP having a first north bridge circuit and a first graphics processing circuit; a second IGP coupled to the first IGP, the second IGP having a second north bridge circuit and a second graphics processing circuit; and a south bridge circuit coupled to the first north bridge circuit.

According to another aspect of the invention, a computer system is disclosed comprising: a main memory module; a CPU having a memory controller coupled with the main memory module; a south bridge circuit; a first integrated graphics processor (IGP) having a first graphics processing circuit and a first north bridge circuit, which bridges the CPU and the south bridge circuit; and a second IGP coupled to the first IGP, the second IGP having a second north bridge circuit and a second graphics processing circuit.

According to another aspect of the invention, a computer system is disclosed comprising: a main memory module; at least one CPU; a south bridge circuit; a first integrated graphics processor (IGP) having a first graphics processing circuit and a first north bridge circuit, which bridges the main memory module, the CPU, and the south bridge circuit; and a second IGP coupled to the first IGP, the second IGP having a second north bridge circuit and a second graphics processing circuit.

According to yet another aspect of the invention, an integrated graphics processor is disclosed comprising: a first north bridge circuit for bridging a CPU and a south bridge circuit when the integrated graphics processor is coupled to the CPU and the south bridge circuit; a bus interface; and a first graphics processing circuit coupled to the first north bridge circuit and the bus interface for, via the bus interface, cooperating with a second graphics processing circuit of another integrated graphics processor, which comprises the second graphics processing circuit and a second north bridge circuit, to perform graphics processing operations.

Thereto, a method for processing graphics is disclosed comprising: providing an integrated graphics processor comprising a first north bridge circuit, a bus interface, and a first graphics processing circuit; and utilizing the first graphics processing circuit to cooperate with a second graphics processing circuit of another integrated graphics processor, which comprises the second graphics processing circuit and a second north bridge circuit, via the bus interface to perform graphics processing operations.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a simplified block diagram of a computer system according to a first embodiment of the present invention.

FIG. 2 is a simplified block diagram of a motherboard of FIG. 1 according to an exemplary embodiment of the present invention.

FIG. 3 is a simplified block diagram of a computer system according to a second embodiment of the present invention.

FIG. 4 is a simplified block diagram of a motherboard of FIG. 3 according to an exemplary embodiment of the present invention.

### DETAILED DESCRIPTION

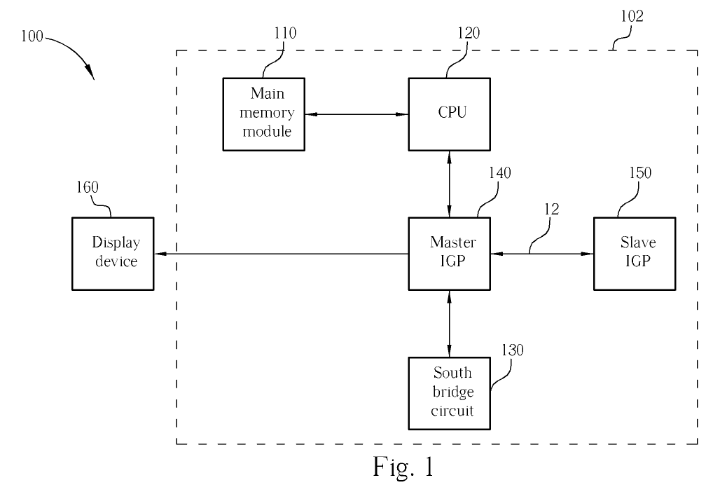

Please refer to FIG. 1, which shows a simplified block diagram of a computer system 100 according to a first embodiment of the present invention. The computer system 100 comprises a main memory module 110, a CPU 120, a south bridge circuit 130, a master integrated graphics processor (IGP) 140, a slave IGP 150, and a display device 160. Note that the term “integrated graphics processor” as used herein encompasses any single chip or processor that integrates at least the functionalities of north bridge and graphics processing. The main memory module 110 is installed on at least one memory slot of a motherboard 102 of the computer system 100. The CPU 120 is typically installed on a CPU socket of the motherboard 102. In this embodiment, the south bridge circuit 130, the master IGP 140, and the slave IGP 150 are positioned on the motherboard 102. As shown in FIG. 1, the slave IGP 150 is coupled to the master IGP 140 through a bus 12 mounted on the motherboard 102.

In the computer system 100, visual output is provided on the display device 160 operating under the control of the master IGP 140. The display device 160 may be a conventional CRT monitor, a LCD monitor, or any other visual output device.

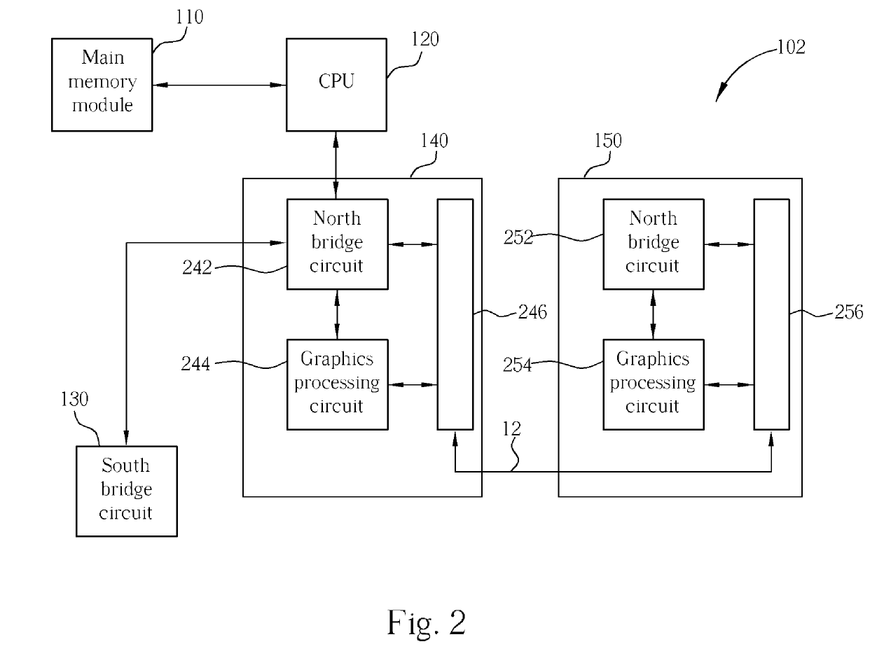

FIG. 2 shows a simplified block diagram of the motherboard 102 of the computer system 100 according to an exemplary embodiment of the present invention. As shown, the master IGP 140 comprises a north bridge circuit 242 for bridging the CPU 120 and the south bridge circuit 130; a graphics processing circuit 244 coupled to the north bridge circuit 242 for performing graphics processing operations; and a bus interface 246 coupled to the north bridge circuit 242 and the graphics processing circuit 244. Similar to the master IGP 140, the slave IGP 150 comprises a north bridge circuit 252, a graphics processing circuit 254, and a bus interface 256.

The graphics processing circuit 254 is utilized for assisting with the graphics processing operations of the graphics processing circuit 244 of the master IGP 140. For example, the graphics processing circuit 254 may be employed to assist with 3D rendering operations of the graphics processing circuit 244. In practice, the graphics processing circuits 244 and 254 may operate in parallel to render respective portions of a frame at the same time or to render different frames, respectively. The graphics processing circuit 244 may further perform any of the currently known load balancing algorithms or those yet to be developed to balance the rendering loads thereof and the rendering loads of the graphics processing circuit 254. In other words, the master IGP 140 cooperates with the slave IGP 150 to implement a graphics processing system for the computer system 100. In one aspect, the graphics processing circuit 254 (or the slave IGP 150) can be regarded as an extra 3D engine for accelerating the 3D rendering performance of the graphics processing circuit 244 of the master IGP 140.

To successfully combine the rendering power of the two graphics processing circuits 244 and 254, the graphics processing circuit 244 of the master IGP 140 is configured to have a compatible instruction set with respect to the graphics processing circuit 254. In a preferred embodiment, the graphics processing circuit 244 is substantially the same as the graphics processing circuit 254. Additionally, the bus 12 is implemented with a high-speed bus capable of communicating between the two graphics processing circuits 244 and 254. For example, the bus 12 may be a PCI-E bus while both the bus interfaces 246 and 256 are PCI-E bus interfaces. Thereto, the bus 12 may be an AGP bus while both the bus interfaces 246 and 256 are AGP bus interfaces. In practice, other high-speed bus and associated bus interfaces may be employed to interconnect the two graphics processing circuits 244 and 254.

In this embodiment, the CPU 120 comprises a memory controller (not shown) for controlling data accessing of the main memory module 110, and both the master IGP 140 and the slave IGP 150 access the main memory module 110 through an unified memory architecture (UMA). The master IGP 140 and the slave IGP 150 can share graphics processing parameters, such as the texture and vertex data by way of the main memory module 110.

As in the foregoing descriptions, it can be appreciated that the north bridge circuit 252 of the slave IGP 150 may not be utilized and, therefore, can be disabled or turned off when it is not in use. For example, the north bridge circuit 252 can be disabled according to a control signal, which may be generated by the graphics processing circuit 244 or by other control unit (not shown) of the motherboard 102, such as the BIOS. In one embodiment, the motherboard 102 generates a control signal to an IGP to disable the north bridge circuit of the IGP when the IGP is not positioned on where a master IGP should be arranged.

In practical applications, the slave IGP 150 and the master IGP 140 can be designed to have identical specifications thereby further reducing the manufacturing cost of each IGP. In addition, the slave IGP 150 can be arranged on an add-on card, which is inserted into a slot (e.g. a PCI-E slot or an AGP slot) of the motherboard 102.

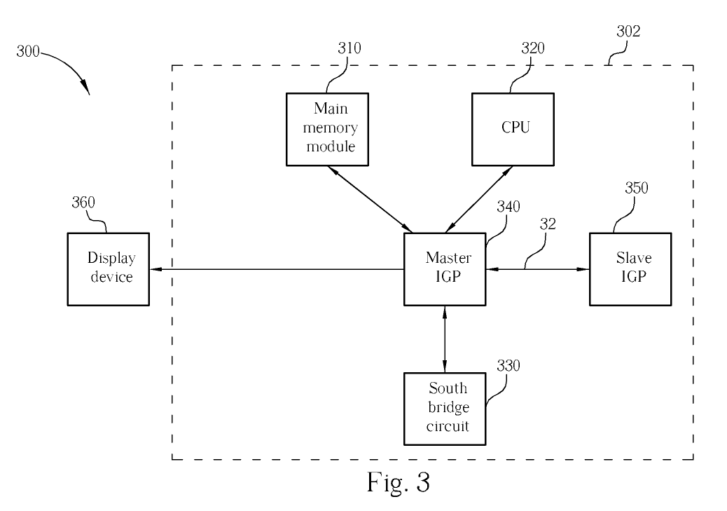

FIG. 3 shows a simplified block diagram of a computer system 300 according to a second embodiment of the present invention. Similar to the above computer system 100, the computer system 300 comprises a main memory module 310, a CPU 320, a south bridge circuit 330, a master IGP 340, a slave IGP 350, and a display device 360. The slave IGP 350 is coupled to the master IGP 340 through a bus 32 (e.g., a PCI-E bus or an AGP bus) mounted on a motherboard 302 of the computer system 300. One difference between the computer systems 100 and 300 is that the master IGP 340 of the computer system 300 is provided with a memory controller (not shown) for controlling data accessing of the main memory module 310. In such a configuration, the master IGP 340 of the computer system 300 bridges not only the CPU 320 and the south bridge circuit 330, but also the main memory module 310. Further details of the computer system 300 are described in below.

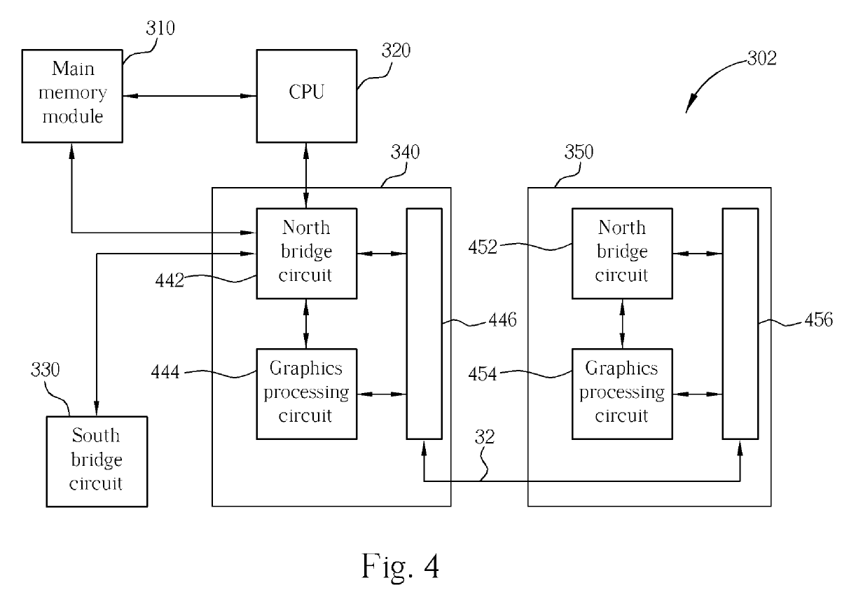

Please refer to FIG. 4, which shows a simplified block diagram of the motherboard 302 of the computer system 300 according to an exemplary embodiment of the present invention. The master IGP 340 comprises a north bridge circuit 442 for bridging the main memory module 310, the CPU 320, and the south bridge circuit 330; a graphics processing circuit 444 coupled to the north bridge circuit 442 for performing graphics processing operations; and a bus interface 446 coupled to the north bridge circuit 442 and the graphics processing circuit 444. As previously described, the master IGP 340 comprises a memory controller that is typically arranged within the north bridge circuit 442. The slave IGP 350 comprises a north bridge circuit 452, a graphics processing circuit 454, and a bus interface 456. The graphics processing circuit 454 is employed to assist with the graphics processing operations, such as with the 3D rendering operations of the graphics processing circuit 444. Similar to the above embodiment, the graphics processing circuit 454 of the slave IGP 350 is designed with a compatible instruction set with respect to the graphics processing circuit 444 of the master IGP 340 to facilitate communications with the graphics processing circuit 444. The cooperation of the graphics processing circuits 444 and 454 is substantially the same as the foregoing graphics processing circuits 244 and 254, and further details are therefore omitted for brevity. Preferably, the graphics processing circuit 444 is substantially the same as the graphics processing circuit 454.

The bus 32 used for connecting the bus interfaces 446 and 456 is a high-speed bus with sufficient bandwidth for facilitating communication between the two graphics processing circuits 444 and 454. A high-speed bus such as a PCI-E bus or an AGP bus can be utilized. In the computer system 300, both the master IGP 340 and the slave IGP 350 access the main memory module 310 via the north bridge circuit 442 by employing the UMA technique. In operations, the master IGP 340 and the slave IGP 350 can share graphics processing parameters, such as the texture and vertex data, via the main memory module 310.

In practical applications, the slave IGP 350 and the master IGP 340 can be designed to have identical specifications thereby reducing the manufacturing cost of each IGP.

As in the aforementioned descriptions, it can be appreciated that the disclosed motherboards with multiple IGPs are feasible for use in Intel P4 platforms, AMD K8 platforms, and various multi-CPU computer systems. Additionally, it should be noted that the number of slave IGPs arranged on a single motherboard is not limited to one. The foregoing multi-IGP architecture can be extended to encompass two or more slave IGPs. The maximum number of slave IGPs that can be arranged on the motherboard is determined by the maximum bandwidth of the bus interface of the master IGP. In practice, different slave IGPs may interconnect to the master IGP via a single bus interface or via different bus interfaces, respectively. For example, suppose that the master IGP comprises a PCI-E bus interface and an AGP bus interface, the master IGP can communicate with some slave IGPs through the PCI-E bus interface while communicating with the other slave IGPs through the AGP bus interface.

In contrast to the prior art, an additional high-speed bridge card is not required in the proposed computer systems. As a result, the hardware cost can be reduced. Additionally, all the master IGP and slave IGPs can be directly mounted onto the motherboard to minimize the required space and thereby reduce the system's volume.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A motherboard comprising:
a first integrated graphics processor (IGP), positioned on the motherboard, the first IGP having a first north bridge circuit and a first graphics processing circuit;
a second IGP coupled to the first IGP, the second IGP having a second north bridge circuit and a second graphics processing circuit; and
a south bridge circuit coupled to the first north bridge circuit.

2. The motherboard of claim 1, wherein the first graphics processing circuit has a compatible instruction set with respect to the second graphics processing circuit.

3. The motherboard of claim 1, wherein the second graphics processing circuit is utilized for assisting with 3D rendering operations of the first graphics processing circuit.

4. The motherboard of claim 1, wherein the second IGP is coupled to the first IGP through a bus mounted on the motherboard.

5. The motherboard of claim 4, wherein the bus is a PCI-Express bus or an AGP bus.

6. The motherboard of claim 1, further comprising:
at least one memory slot, for installing a main memory module; and
a CPU socket for installing a CPU having a memory controller for controlling data accessing of the main memory module;
wherein the first north bridge circuit bridges the CPU socket and the south bridge circuit.

7. The motherboard of claim 1, further comprising:
at least one memory slot for installing a main memory module; and
at least one CPU socket, each for installing a CPU;
wherein the first north bridge circuit bridges the CPU socket, the memory slot, and the south bridge circuit.

8. The motherboard of claim 1, wherein the second north bridge circuit is disabled.

9. The motherboard of claim 1, wherein the first IGP is a master IGP while the second IGP is a slave IGP.

10. The motherboard of claim 9, wherein the first graphics processing circuit is utilized for performing graphics processing operations while the second graphics processing circuit is utilized for assisting with the graphics processing operations of the first graphics processing circuit.

11. A computer system comprising:
a main memory module;
a CPU having a memory controller coupled with the main memory module;
a south bridge circuit;
a first integrated graphics processor (IGP) having a first graphics processing circuit and a first north bridge circuit, wherein said first north bridge circuit bridges the CPU and the south bridge circuit; and
a second IGP coupled to the first IGP, the second IGP having a second north bridge circuit and a second graphics processing circuit.

12. The computer system of claim 11, wherein the first graphics processing circuit has a compatible instruction set with respect to the second graphics processing circuit.

13. The computer system of claim 11, wherein the second graphics processing circuit is utilized for assisting with 3D rendering operations of the first graphics processing circuit.

14. The computer system of claim 11, wherein the second IGP is coupled to the first IGP through a bus mounted on a motherboard of the computer system.

15. The computer system of claim 14, wherein the bus is a PCI-Express bus or an AGP bus.

16. The computer system of claim 11, wherein the first IGP and second IGP access the main memory module through a unified memory architecture.

17. The computer system of claim 11, wherein the first IGP is a master IGP while the second IGP is a slave IGP.

18. A computer system comprising:
a main memory module;
at least one CPU;
a south bridge circuit;
a first integrated graphics processor (IGP) having a first graphics processing circuit and a first north bridge circuit, wherein the first north bridge circuit bridges the main memory module, the CPU, and the south bridge circuit; and
a second IGP coupled to the first IGP, the second IGP having a second north bridge circuit and a second graphics processing circuit.

19. The computer system of claim 18, wherein the first graphics processing circuit has a compatible instruction set with respect to the second graphics processing circuit.

20. The computer system of claim 18, wherein the second graphics processing circuit is utilized for assisting with 3D rendering operations of the first graphics processing circuit.

21. The computer system of claim 18, wherein the second IGP is coupled to the first IGP through a bus mounted on a motherboard of the computer system.

22. The computer system of claim 21, wherein the bus is a PCI-Express bus or an AGP bus.

23. The computer system of claim 18, wherein the first IGP and second IGP access the main memory module through a unified memory architecture.

24. The computer system of claim 18, wherein the first IGP is a master IGP while the second IGP is a slave IGP.

25. An integrated graphics processor comprising:
a first north bridge circuit for bridging a CPU and a south bridge circuit when the integrated graphics processor is coupled to the CPU and the south bridge circuit;
a bus interface; and
a first graphics processing circuit coupled to the first north bridge circuit and the bus interface for, via the bus interface, cooperating with a second graphics processing circuit of another integrated graphics processor, which comprises the second graphics processing circuit and a second north bridge circuit, to perform graphics processing operations.

26. The integrated graphics processor of claim 25, wherein the integrated graphics processor is a single chip.

27. The integrated graphics processor of claim 25, wherein the graphics processing operations comprises 3D rendering operations.

28. The integrated graphics processor of claim 25, wherein the first graphics processing circuit has a compatible instruction set with respect to the second graphics processing circuit.

29. The integrated graphics processor of claim 25, wherein the bus interface comprises a PCI-Express bus interface, an AGP bus interface, or both.

30. The integrated graphics processor of claim 25, wherein the first graphics processing circuit accesses a main memory module of a computer system through a memory controller of a CPU of the computer system while performs the graphics processing operations.

31. The integrated graphics processor of claim 25, wherein the first north bridge circuit comprises a memory controller, and the first graphics processing circuit accesses a main memory module of a computer system through the memory controller while performs the graphics processing operations.

32. A method for processing graphics, comprising:
providing an integrated graphics processor comprising a first north bridge circuit, a bus interface, and a first graphics processing circuit; and
utilizing the first graphics processing circuit to cooperate with a second graphics processing circuit of another integrated graphics processor, which comprises the second graphics processing circuit and a second north bridge circuit, via the bus interface to perform graphics processing operations.
